(19) United States
(12) Patent Application Publication
(10) Pub. No.: US 2016/0195343 A1
(43) Pub. Date: Jul. 7, 2016

(54) OUTDOOR DEVICE FOR AN AIR CONDITIONER AND A METHOD OF MANUFACTURING A SIDE SUPPORTER FOR AN OUTDOOT DEVICE FOR AN AIR CONDITIONER

(71) Applicant: LG ELECTRONICS INC., Seoul (KR)

(72) Inventors: Jonghwan JEUNG, Seoul (KR); Jaewan LEE, Seoul (KR); Kyomin KOO, Seoul (KR)

(21) Appl. No.: 14/987,934

(22) Filed: Jan. 5, 2016

(30) Foreign Application Priority Data
Jan. 5, 2015 (KR) 10-2015-0000843

(51) Int. Cl. F28F 9/007; F16M 13/02

(52) U.S. Cl. CPC F28F 9/007; F16M 13/02

(57) ABSTRACT

An outdoor device for an air conditioner and a method for manufacturing a side supporter for an outdoor device for an air conditioner are provided. The outdoor device may include a top cover that forms an upper surface of the outdoor device and in which a plurality of discharge ports is formed, a base pan that forms a lower surface of the outdoor device, an outdoor heat exchanger that extends along a periphery of the base pan, a plurality of side supporters that connects the top cover and the base pan and forms corners of the outdoor device, and a plurality of outer panels provided between the plurality of side supporters and coupled to the plurality of side supporters to form a shape of an outer periphery of the outdoor device. A plurality of suction ports, through which outside air may be suctioned, may be formed in a region of the plurality of outdoor panels corresponding to the outdoor heat exchanger, including the plurality of side supporters.

### CROSS-REFERENCE TO RELATED APPLICATION(S)

This application claims priority under 35 U.S.C. §119 to Korean Application No. 10-2015-0000843, filed in Korea on Jan. 5, 2015, whose entire disclosure is hereby incorporated by reference.

### BACKGROUND

1. Field

An outdoor device for an air conditioner and a method of manufacturing a side supporter for an outdoor device for an air conditioner are disclosed herein.

2. Background

An air conditioner is a home appliance that maintains air in a room or indoor space in a most suitable condition according to an application and purpose. The air conditioner adjusts the room or indoor space to a cooling condition in summer and to a heating condition in winter, adjusts a humidity in the room or indoor space, and adjusts the air in the room or indoor space to be in a pleasant and clean condition. In the air conditioner, a refrigeration cycle for performing compression, condensation, expansion, and evaporation of a refrigerant is driven, and therefore a cooling or heating operation of the indoor space may be performed.

Such an air conditioner may be classified as a split type air conditioner, in which an indoor unit or device and an outdoor unit or device are separated from each other, and a window type air conditioner, in which the indoor device and the outdoor device are combined in one device according to whether the indoor device and the outdoor device are separated from each other. The outdoor device may include an outdoor heat exchanger that exchanges heat with outdoor air, and the indoor device may include an indoor heat exchanger that exchanges heat with indoor air.

When the refrigeration cycle performs the cooling operation, the outdoor heat exchanger may function as a condenser, and the indoor heat exchanger may function as an evaporator. On the other hand, when the refrigeration cycle performs the heating operation, the indoor heat exchanger may function as the condenser, and the outdoor heat exchanger may function as the evaporator.

In recent years, a multi-type air conditioner, in which a plurality of outdoor devices are disposed outdoors, such as on a rooftop of a building, and an indoor device that independently cools and heats each indoor space is connected to the outdoor device to constitute a refrigerant circuit has been widely used as the air conditioner.

In Korean Patent Publication No. 10-2013-0088434, which is hereby incorporated by reference, a related art multi-type air conditioner is disclosed. In the outdoor device according to the related art multi-type air conditioner, individual components forming the refrigeration cycle, including a compressor, are mounted on an upper surface of a base pan, and the outdoor heat exchanger is disposed or provided along a periphery of the base pan to be exposed on three sides. Then, a left panel and a right panel, in which a suction port is formed, are provided on left and right sides corresponding to the heat exchanger, and a suction grill is formed on a rear surface of the heat exchanger to allow outdoor air to pass through the outdoor heat exchanger.

However, in such an outdoor device according to the prior art, the entire structure of the outdoor device is formed in a rectangular parallelepiped, and particularly, in a corner portion or corner of two sides of the rectangular parallelepiped, only a structure in which panels forming an appearance of the outdoor device are connected to each other is configured without a separate support structure, and therefore, a load strength of a product is poor, such that the corner portion may be damaged when a shock is applied to the corner portion the transport or installation of the outdoor device, for example. In addition, when the outdoor device passes through an elevator or a door upon installation and transport of the outdoor device, the corner portion may be caught in the elevator or the door, and the whole product should be carried or pushed to be transported in order to prevent the corner portion from being caught, resulting in a decrease in mobility of the outdoor device.

### BRIEF DESCRIPTION OF THE DRAWINGS

Embodiments will be described in detail with reference to the following drawings in which like reference numerals refer to like elements, and wherein:

FIG. 1 is a perspective view of an outdoor device of an air conditioner according to an embodiment;

FIG. 2 is an exploded perspective view showing a coupling structure of components forming an appearance of the outdoor device of FIG. 1;

FIG. 3 is a plan view showing an inside of the outdoor device of FIG. 1;

FIG. 4 is an exploded perspective view showing a coupling structure of a side supporter and an outer panel according to an embodiment;

FIG. 5 is a partial cross-sectional view showing a portion at which the side supporter and the outer panel of FIG. 4 are coupled to each other;

FIG. 6 is a partial perspective view showing the side supporter of FIG. 4;

FIG. 7 is a perspective view of a side supporter according to another embodiment;

FIGS. 8A-8E are views sequentially showing changes in shape of the side supporter according to a method of manufacturing a side supporter according to an embodiment;

FIG. 9 is a schematic view showing a method of bending of the side supporter; and

FIG. 10 is a perspective view showing an outdoor device of an air conditioner according to another embodiment.

### DETAILED DESCRIPTION

Hereinafter, embodiments will be described in detail with reference to the accompanying drawings. The embodiments may, however, be embodied in many different forms and should not be construed as being limited to the embodiments set forth herein; rather, alternate embodiments falling within the spirit and scope will fully convey the concept to those skilled in the art.

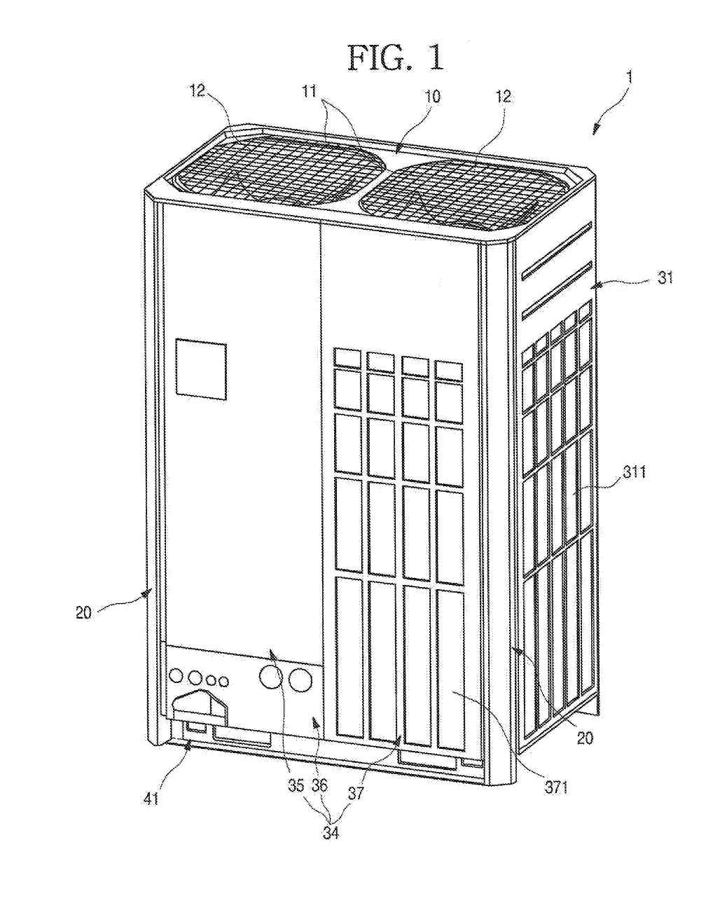

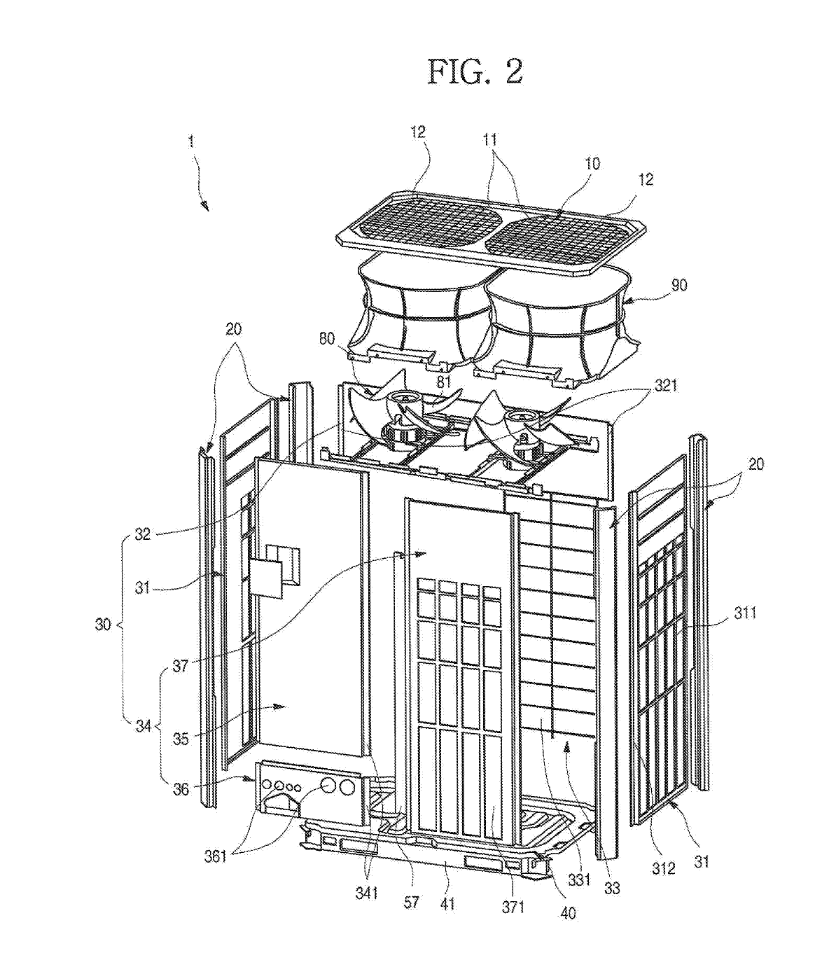

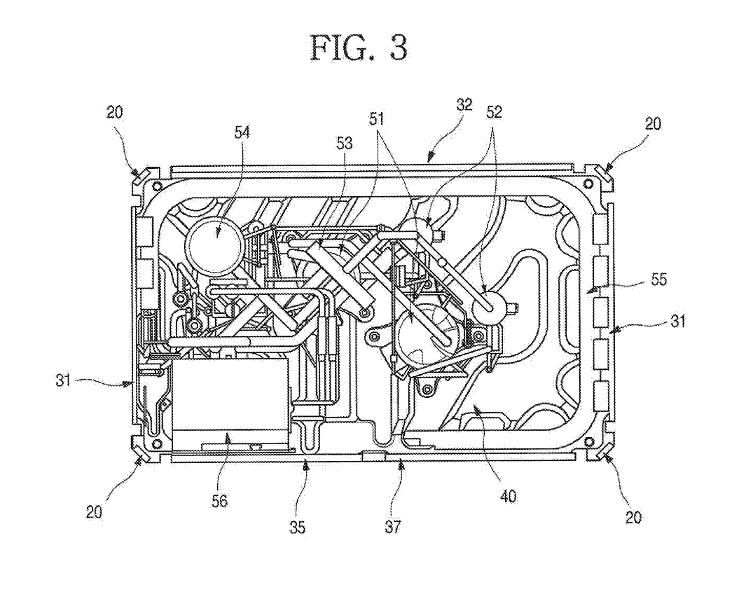

FIG. 1 is a perspective view of an outdoor device of an air conditioner according to an embodiment. FIG. 2 is an exploded perspective view showing a coupling structure of components forming an appearance of the outdoor device of FIG. 1. FIG. 3 is a plan view showing an inside of the outdoor device of FIG. 1.

As shown in FIGS. 1 to 3, an air conditioner according to an embodiment may include an outdoor unit or device 1 disposed or provided outdoors and an indoor unit or device (not shown) connected to the outdoor device 1 by a refrigerant pipe and disposed or provided indoors. The indoor device may include an indoor heat exchanger (not shown) that exchanges heat with indoor air.

An overall appearance of the outdoor device 1 may be formed by a top cover 10, a plurality of outer panels 30, a base pan 40, and a plurality of side supporters 20. The top cover 10 may be provided on or at an upper surface of the outdoor device 1 to form an appearance of an upper surface of the outdoor device 1. A plurality of discharge ports 11 may be formed in the top cover 10, so that air heat-exchanged inside of the outdoor device 1 may be discharged outside of the outdoor device 1. A discharge grill 12 may be mounted in each of the plurality of discharge ports 11, so that it is possible to prevent external foreign substances from being introduced into the plurality of discharge ports 11.

The plurality of side supporter 20 may be provided in or at four corners of the outdoor device 1. The plurality of side supporter 20 may each be bent so that the side supporter 20 may connect the top cover 10 and the base pan 40 to form a corner of the outdoor device 1, or formed in a pipe-shape. The plurality of outer panels 30 may be provided between the plurality of side supporters 20 to form an appearance of a peripheral surface of the outdoor device 1.

Each side supporter 20 may form a space between the respective outer panels 30 connected to the respective side supporter 20, and form an inclined surface between the respective outer panels 30 so that the respective corner of the outdoor device 1 has the inclined surface.

The plurality of outer panels 30 may include a pair of side panels 31 that respectively form left and right or first and second side surfaces of the outdoor device 1, a front panel 34 that forms a front surface of the outdoor device 1, and a rear panel 32 that forms a rear surface of the outdoor device 1. The plurality of side panels 31 may form the left or first side surface and the right or second side surface of the outdoor device 1, and may be formed in a single plate shape that connects neighboring side supporters 20, the base pan 40, and the top cover 10.

An upper portion of each side panel 31, that is, a region corresponding to one or more shroud 90 inside of the outdoor device 1 may be solid, and a plurality of suction ports 311 may be formed in a lower remaining region except for the solid region. The plurality of suction ports 311 may be uniformly distributed over an entire region, in which an outdoor heat exchanger 55 that exchanges heat with suctioned air may be positioned, and guide air suctioned from a lateral side to pass through the outdoor heat exchanger 55. A position of the plurality of suction ports 311 formed in each side panel 31 may be changed according to a structure and position of the outdoor heat exchanger 55, and the plurality of suction ports 311 may be provided in a region corresponding to the outdoor heat exchanger 55 and configured in such a manner that a portion not corresponding to the outdoor heat exchanger 55 may be solid so that suctioned air may all passes through the outdoor heat exchanger 55.

In left and right or first and second ends or sides of each side panel 31, a side panel coupling portion 312 bent to be coupled to the side supporter 20 may be formed or provided. The side panel coupling portion 312 may be bent toward the inside of the outdoor device 1, and then further bent toward the outside from an extending end of the outdoor heat exchanger 55 to have a structure which may be coupled to a coupling portion 223 of the side supporter 20, which will be described hereinafter.

On a rear surface of the outdoor device 1, the rear panel 32 may be provided in or at a portion corresponding to a position of the one or more shroud 90. A suction grill 33 may be formed from a lower end of the rear panel 32 to the base pan 40. The suction grill 33 may be formed in a grid pattern by a plurality of wires, and may have a size corresponding to the outdoor heat exchanger 55 positioned on the outdoor device 1, for example. Thus, the suction grill 33 may allow a smooth inflow of outdoor air while protecting the outdoor heat exchanger 55 from an external impact or foreign substances.

In the left and right or first and second ends of the rear panel 32, a rear panel coupling portion 321 bent to be coupled to the side supporter 30 may be further provided. The rear panel coupling portion 321 may be bent toward the inside of the outdoor device 1, and then further bent toward the outside from an extending end of the outdoor heat exchanger 55 to have a structure by which it may be coupled to the coupling portion 223 of the side supporter 20, which will be described hereinafter.

On a front surface of the outdoor device 1, the front panel 34 including a plurality of panels may be provided. The front panel 34 may include a service panel 35, a piping panel 36, and a suction panel 37.

The front surface of the outdoor device 1 may be divided into left and right or first and second sides with respect to a point from which the outdoor heat exchanger 55 extends. That is, on the left or first side of the outdoor device 1, the service panel 35 and the piping panel 36 may be provided, and on the right or second side of the outdoor device 1, the suction panel 37 may be provided.

The service panel 35 may be provided in or at a position corresponding to the extending end of the outdoor heat exchanger 55 in or at a left or first end of the outdoor device 1. The service panel 35 may be configured to be independently detachable in a state in which the plurality of panels included in the front panel 34 are all mounted. Thus, by attaching or detaching the service panel 35, internal components of the outdoor device 1 may be accessed. In particular, when opening the service panel 35, a whole control box 56 may be exposed to a front side, so that easy access to the individual components forming the refrigeration cycle and the refrigerant pipe connecting the individual components is possible.

A plurality of indoor device connection pipes that connects the outdoor device 1 and the indoor device may pass through the piping panel 36 and be fixed thereto. The piping panel 36 may be provided between a lower end of the service panel 35 and the base pan 40. The piping panel 36 may have a same width as a width of the service panel 35, and the service panel 35 may be formed to be separated from the piping panel 36 in a state in which the piping panel 36 is fixed and mounted to the base pan 40.

A plurality of pipe installation holes 361, through which the plurality of indoor device connection pipes, which may be connected to the indoor device may pass, may be formed in the piping panel 36. A service valve may be installed in each of the plurality of pipe installation holes 361 to facilitate connection and installation of the indoor device connection pipe connected to the indoor device. The piping panel 36 may be formed integrally with the service panel 35, as necessary.

The suction panel 37 may form the appearance of a remaining portion of the front surface of the outdoor device 1 except for the service panel 35 and the piping panel 36. The suction panel 37 may extend from the top cover 10 to the base pan 40, and extend from the side supporter 20 to the service panel 35 and the piping panel 36.

The suction panel 37 may extend up to the end of the outdoor heat exchanger 55, and allow a coupling plate 57, which may be provided inside of the outdoor device 1 and by which the end of the outdoor heat exchanger 55 may be fixed and the end of the suction panel 37 to be connected to each other. Thus, the outdoor heat exchanger 55 may be maintained in a stable fixed state by the suction panel 37. The suction panel 37 may shield an upper portion corresponding to the position of the one or more shroud 90, and a plurality of suction ports 371 may be formed in a remaining region corresponding to a region of the outdoor heat exchanger 55 to allow outdoor air to flow toward the outdoor heat exchanger 55.

In left and right or first and second ends or sides of each of the plurality of panels forming the front panel 34, a front panel coupling portion 341 bent to be coupled to the side supporter 20 or a neighboring another front panel 34 may be formed. The front panel coupling portion 341 may be bent toward the inside of the outdoor device 1, and then further bent toward the outside from the extending end of the outdoor heat exchanger 55 to have a structure by which it may be coupled to the coupling portion 223 of the side supporter 20, which will be described hereinafter.

A bottom surface of the outdoor device 1 may be formed by the base pan 40. The outdoor device 1 may be supported in a state of being spaced apart from a surface, such as a floor, by a base frame 41. In addition, on a top surface of the base pan 40, components, such as one or more compressor 51, and the outdoor heat exchanger 55, for example, which form the refrigeration cycle may be provided.

More specifically, on the top surface of the base frame 41, the one or more compressor 51 may be provided. The one or more compressor 51 may compress a refrigerant in a gas state to a high temperature and high pressure, and each of a constant-speed compressor rotated at a constant speed to compress the refrigerant to have a constant capacity, and an inverter compressor, whose rotational speed is variable according to a load to adjust a compression capacity may be provided in or as the one or more compressor 51. In the refrigerant pipe connected to the outlet of each of the constant-speed compressor and the inverter compressor of the one or more compressor 51, an oil separator 52 that separates oil contained in refrigerant discharged from the compressor 51 may be provided to separate oil contained in discharged refrigerant and recover the separated oil back to the compressor 51.

On one side of the outdoor device 1, a four-way valve 53 that allows the refrigerant having passed through the oil separator 52 to be selectively supplied to the indoor heat exchanger (not shown) or the outdoor heat exchanger 55 may be provided. The four-way valve 53 may be connected to each of the indoor heat exchanger, the outdoor heat exchanger 55, the one or more compressor 51, and an accumulator 54, and switch the corresponding flow path so that the refrigerant discharged from the compressor 51 may be selectively supplied to the indoor heat exchanger and the outdoor heat exchanger 55 according to a cooling operation or a heating operation.

The accumulator 54 may be connected to the indoor heat exchanger and the four-way valve 53 on or at one side of the base pan 40. The accumulator 54 may allow the refrigerant in the liquid state to be stored and the refrigerant in the gas state to be supplied to the one or more compressor 51, by separating the introduced refrigerant in the liquid state and refrigerant in the gas state.

The outdoor heat exchanger 55 may exchange heat between outdoor air and the refrigerant, and heat exchange may be carried out between the outdoor air and the refrigerant while the outdoor air is forcibly passed through the outdoor heat exchanger 55 by a blowing fan 81 of one or more fan blowing assembly 80.

The outdoor heat exchanger 55 may extend along a periphery of the base pan 40 and be provided along four sides of the outdoor device 1. Ends of the outdoor device 1 may be spaced apart from each other in a corner formed by a left or first surface and a front or second surface of the outdoor device 1, and generate a predetermined space. The space between the ends of the outdoor device 1 may be open when the service panel 35 is separated, so as to provide access to various pipes forming the refrigeration cycle and the control box 56 through this space.

The outdoor heat exchanger 55 may extend from the base pan 40 up to a height adjacent to the one or more blowing fan assembly 80. Thus, the outdoor heat exchanger 55 may cover all of the plurality of suction ports 311, 331, and 371 inside of the outdoor unit 1, and allow all of the air passing through the plurality of suction ports 311, 331, and 371 to pass through the outdoor heat exchanger 55.

The one or more shroud 90 may be mounted in or at an inner upper portion of the outdoor device 1, and the one or more fan motor assembly 80 may be provided inside of the one or more shroud 90, respectively. The one or more shroud 90 may guide the discharged air and be opened in a vertical direction, and a side surface of each shroud 90 may be rounded in such a manner that a center of the shroud 90 is recessed inwardly, and an opening of the shroud 90 may be increased as it extends from the center of the shroud 90 toward an upper portion thereof. The opened top surface of the respective shroud 90 may have a same shape as a shape of one of the plurality of discharge ports 11 to effectively guide the discharged air to the respective discharge port 11.

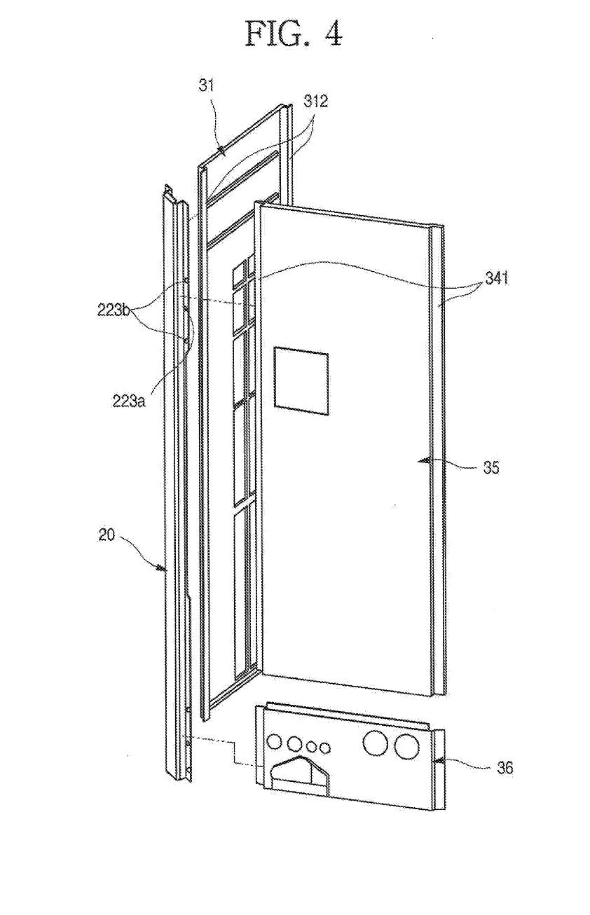

Hereinafter, a configuration of the side support will be described with reference to FIGS. 4 to 6.

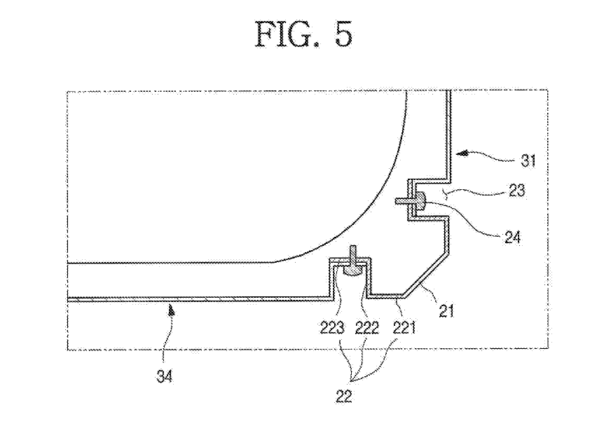

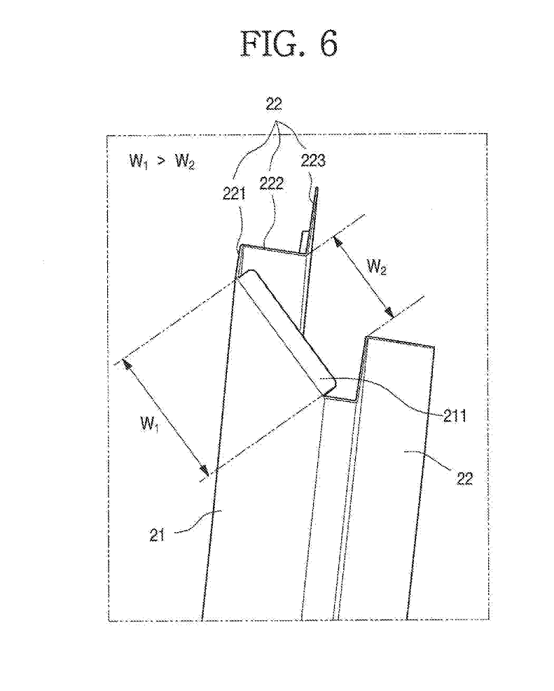

FIG. 4 is an exploded perspective view showing a coupling structure of a side supporter and an outer panel according to an embodiment. FIG. 5 is a partial cross-sectional view showing a portion at which the side supporter and the outer panel of FIG. 4 are coupled to each other. FIG. 6 is a partial perspective view showing the side supporter of FIG. 4.

As shown in the drawings, the side supporter 20 may extend from a surface on which the outdoor device 1 may be installed to the top cover 10, and may be provided at four corners of the outdoor device 1 to form a structure that supports the outdoor device 1 as a whole. In addition, the side supporter 20 may form an inclined corner surface of the outdoor device 1, and may be provided between the front surface and the side surface of the outdoor device 1 or between the plurality of outer panels 30 forming the side surface and the rear surface so that the side supporter 20 may be coupled to the outer panels 30. The side supporter 20 may be made of a planar metallic material, may be consecutively bent, and may include an inclined surface 21 that forms the corner of the outdoor device 1 and a pair of extending surfaces 22, which may be formed at both ends of the inclined surface 21 and consecutively bent to be coupled to the plurality of outer panels 30.

An upper portion of the side supporter 20 may be inserted into the top cover 10, and a bent portion 211 bent inwardly may be formed in or at an upper end of the inclined surface 21 to support the top cover 10 from below the top cover 10.

A configuration of the side supporter 20 will be described hereinafter. The inclined surface 21 may be formed in or at a center of the side supporter 20 in a lateral direction. The inclined surface 21 may form the corner surface of the outdoor device 1, may be formed to have a width capable of generating a space between neighboring outer panels 30, and may extend from an upper end of the outdoor device 1 to a lower end thereof along a length of the side supporter 20.

The pair of extending surfaces 22 may form left and right or first and second sides of the side supporter 20. The pair of extending surfaces 22 may extend from the left and right or first and second ends of the inclined surface 21, and may be formed to be consecutively bent. The pair of extending surface 22 may be symmetrical to each other at the first and second ends of the inclined surface 21, and may have a same structure and shape.

The pair of extending surfaces 22 may include a first side surface 221, a second side surface 222, and the coupling portion 223, which may be formed in or at first and second ends of the second side surface 222. The first side surface 221 may extend from the first and second side ends of the inclined surface 21 and may be bent at a predetermined angle. When the first side surface 221 is connected to the outer plurality of panels 30 connected to the coupling portion 223, for example, the side panel 31 and the service panel 35 in a state in which the first side surface 221 is bent, the first side surface 221 may be coplanar with the side panel 31 and the service panel 35, which may be coupled to the coupling portion 223. That is, the first side surface 221 may form both side surfaces of the outdoor device 1 or an end of the rear surface thereof.

The second side surface 222 may be bent from the extending end of the first side surface 221 in an inward direction of the outdoor device 1. The second side surface 222 may extend a predetermined length, and a vertical groove 23 may be formed in an exposed portion of the side supporter 20, that is, between the first side surface 221 and the outer panel 30 connected to the side supporter 20, and may be bent in a manner to cross the first side surface 221 perpendicularly. A width and depth of an opening of the vertical groove 23 may be determined by an angle at which the second side surface 222 is bent and an extending length of the second side surface 222. The vertical groove 23 may be provided on the first and second sides on the basis of the corner of the outdoor device 1, and when the outdoor device 1 is transported or installed, a user may put his or her hand into the vertical groove 23, thereby improving mobility of the outdoor device 1.

The coupling portion 223 may be bent outwardly from the extending end of the second side surface 222. The coupling portion 223 may be coupled to the panel coupling portions, which may be bent in the outer panel 30, and may be coupled to the panel coupling portions in a coupling or engaging method by a separate coupling member 24, such as a screw. Thus, a coupling hole 223a, to which the coupling member 24 may be fastened or an engaging portion 223b engaged with the panel coupling portion may be formed in the coupling portion 223. The coupling portion 223 may be coupled to the panel coupling portion in a manner to be overlapped with each other, and formed to be bent to have an angle corresponding to the panel coupling portion.

The pair of extending surfaces 22, which may extend from the ends of the inclined surface 21 in a state in which the side supporter 20 is molded, may be provided to face each other, and may be formed in a state of being opened toward the inside of the outdoor device 1. A lateral width W₁ of the inclined surface 21 may correspond to a distance W₂ between left and right or first and second sides of a point in which the second side surface 222 and the coupling portion 223 are connected to each other.

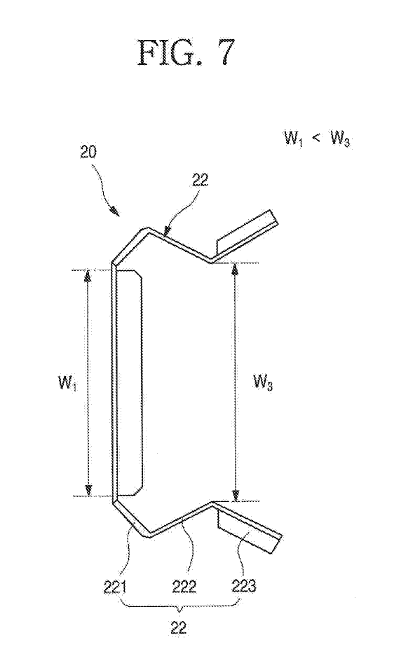

FIG. 7 is a perspective view of a side supporter according to another embodiment. As shown in FIG. 7, the side supporter 20 may have various other structures according to a degree to which the pair of extending surfaces 22 are bent.

The pair of extending surfaces 22 may be formed at the first and second ends of the inclined surface 21 of the side supporter 20, and each of the pair of extending surfaces 22 may include first side surface 221, second side surface 222, and coupling portion 223. In this instance, the configuration of the extending surfaces 22 may be the same as that of the extending surfaces 22 of the side supporter 20 described with respect to FIG. 6.

However, a lateral width of the inclined surface 21 may be formed to be smaller than a distance between first and second sides of a point at which the second side surface 222 and the coupling portion 223 are connected to each other. That is, a distance W3 between the pair of extending surfaces 22 opened toward the inside of the outdoor device 1 may be larger than the width W1 of the inclined surface 21. In the above-described structure, a die for forming the pair of extending surfaces 22 may be easily taken in/taken out, and therefore, it is possible to more easily mold the side supporter 20 with a simple mold structure.

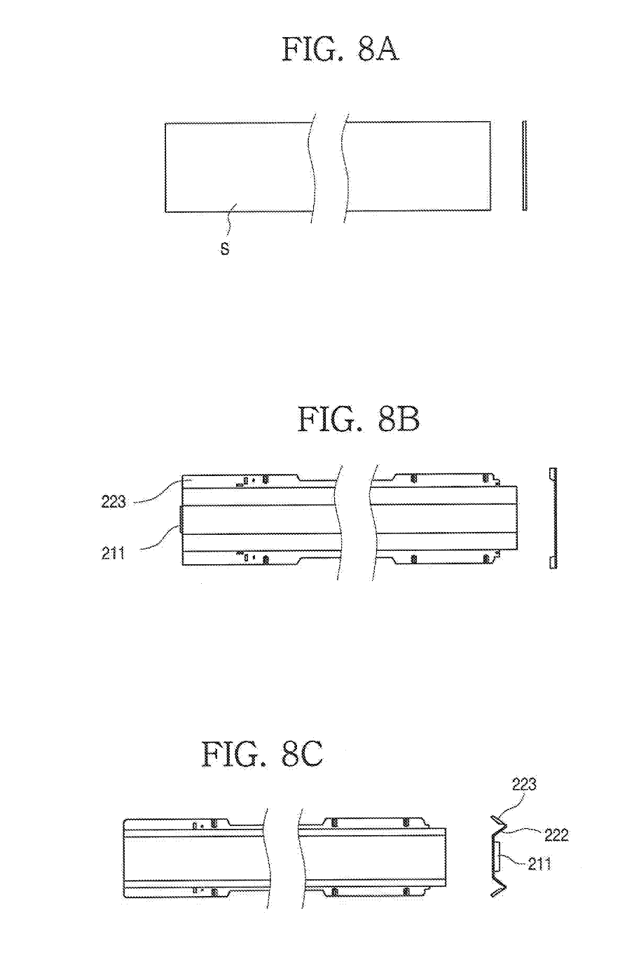

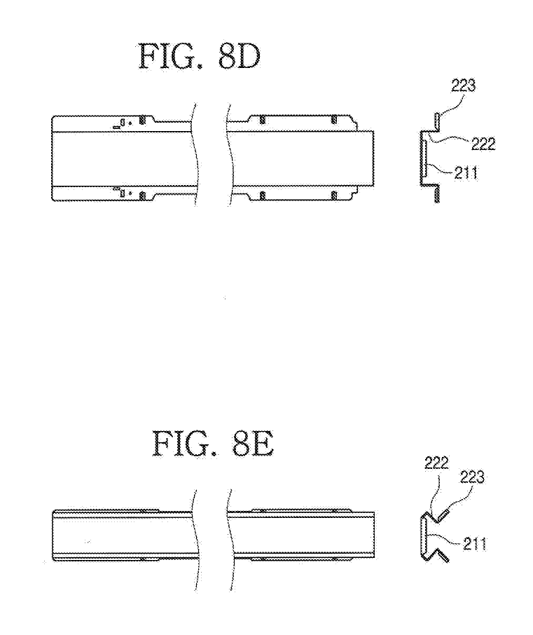

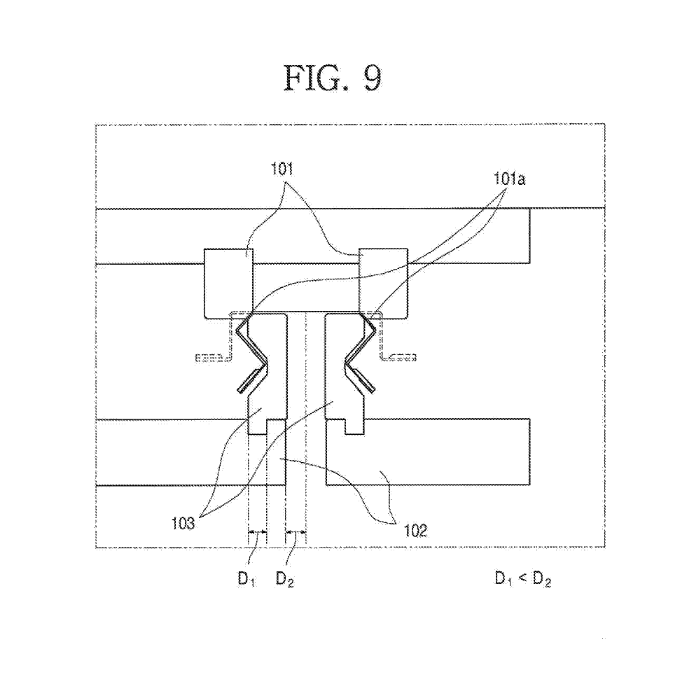

Hereinafter, a method for molding a side supporter of an air conditioner according to an embodiment having the above-described structure will be described with reference to FIGS. 8 and 9.

FIGS. 8A-8E are views sequentially showing changes in shape of the side supporter according to a method of manufacturing of a side supporter according to an embodiment. FIG. 9 is a schematic view showing a method of bending of the side supporter.

In order to mold the side supporter 20, a metal sheet S corresponding to an entire length and width of the side supporter 20 may be first supplied, as shown in FIG. 8A. A portion of each of upper and lower ends and left and right side ends of the supplied metal sheet S may be cut by press working, and therefore, a portion of each of an appearance of the bent portion 211 and the coupling portion 223 may be formed as shown in FIG. 8B. In addition, at a time of press working, a coupling hole 223a formed in the coupling portion 223 or an engaging portion 223b engaged with the panel coupling portion may be simultaneously molded.

Next, the inclined surface 21 may be formed by press working, and primary bending may be performed by press working so that the pair of extending surfaces may be formed on both first and second ends of the inclined surface 21. By the primary bending, the bent portion 211 may be bent, and at a same time, the coupling portion 223 and the second side surface 222 may be primarily molded by bending, as shown in FIG. 8C.

After the primary molding of the pair of extending surfaces 22, the pair of extending surfaces 22 may be further bent by press working once more. That is, by a secondary bending, the second side surface 222 and the coupling portion 223 extending from the second side surface 222 may be completely molded, as shown in FIG. 8D.

Finally, in a state in which the second side surface 222 and the coupling portion 223 are molded, molding of the pair of extending surfaces 22 may be completed by final press working. That is, the first side surface 221 may be finally molded by third bending, as shown in FIG. 8E.

In a third bending, a molding portion 101a to mold the first side surface 221 may be formed in an upper die 101, and a pair of cam punches 103 capable of sliding laterally may be provided in a lower die 102 to be inserted between the opened extending surfaces 22 of the side supporter 20. In a state in which the pair of cam punches 103 is inserted between the pair of extending surfaces 22 in order to mold the pair of extending surfaces 22, and then slidably moved in outward directions, the first side surface 221 and the pair of extending surfaces 22 may be simultaneously molded while the upper die 101 is moved downward. In this instance, the pair of extending surfaces 22 provided on both sides may be simultaneously molded, and after the molding of the pair of extending surfaces 22, the pair of cam punches 103 may be slidably moved again in a direction in which the pair of cam punches 103 become closer to each other, so they can be removed from the opening formed by the pair of extending surfaces 22.

For this, an escape distance D1 of the pair of cam punches 103 which may be recessed in order to mold the pair of extending surfaces 22 may be shorter than a sliding distance D2 of the pair of cam punches 103. Thus, by the above-described structure of the pair of cam punches 103, the pair of cam punches 103 may allow the pair of extending surfaces 22 to be simultaneously molded. The pair of extending surfaces 22 may be molded twice using a single cam punch or alternately using the pair of cam punches, as necessary, and in this case, it is relatively free from constraints of size and shape of the cam punch.

Meanwhile, an air conditioner according to various embodiments other than the air conditioner according to the above-described embodiment may be possible.

An outdoor unit or device of an air conditioner according to another embodiment may include a plurality of supporter suction ports formed on an inclined surface of a side supporter, so that suction of outdoor air may be possible even in a corner side of the outdoor device. In the air conditioner according to this embodiment, other configurations except a shape of the supporter may be the same as those of the previous embodiment, and thus, repeated description thereof has been omitted.

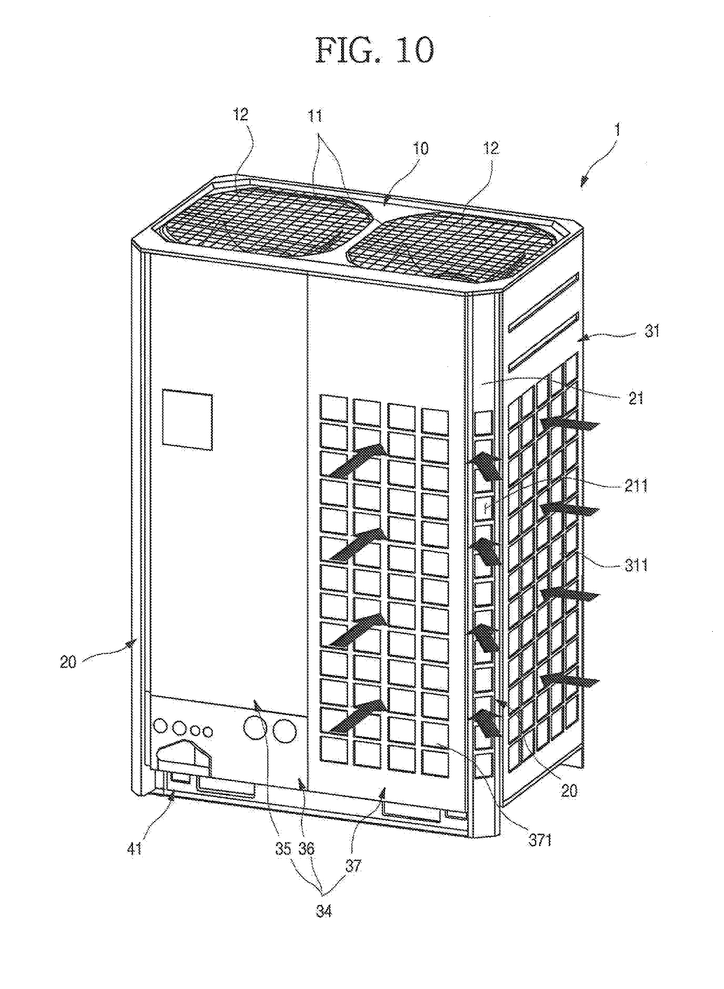

FIG. 10 is a perspective view showing an outdoor device of an air conditioner according to another embodiment. As shown in FIG. 10, an appearance of outdoor device 1 of an air conditioner according to another embodiment may be formed by top cover 10, base pan 40 that forms the bottom surface of the outdoor device 1, base frame 41 that supports the base pan 40, side supporters provided between the top cover 10 and the base pan 40 to form corners of the outdoor device 1, and a plurality of outer panels, which may be connected between the side supporters 20 to form a periphery of the outdoor device 1, in a same manner as that of the previous embodiment.

Although not shown, components, such as one or more compressor 51, oil separator 52, outdoor heat exchanger 55, and accumulator 54, for example, which form a refrigeration cycle, one or more fan motor assembly 80, one or more shroud 90, and control box 56 to control these components, for example, may be provided inside of the outdoor device 1. The outdoor heat exchanger 55 may extend along four sides, and may be provided along the periphery of the base pan 40. A plurality of suction ports 311, 331, and 371 may be provided in the plurality of outer panels 30 in a region corresponding to the outdoor heat exchanger 55, so that suction of outdoor air may be possible in the four surfaces of the outdoor device 1.

The overall structure of the side supporters 20 forming the corners of the outdoor device 1 may be the same as that in the previous embodiment, but a plurality of supporter suction ports 212 may be formed on the inclined surface 21 forming the corners of the outdoor device 1. The plurality of supporter suction ports 211 may be consecutively provided at regular intervals along the inclined surface 21, and extend from an upper end of the base pan 40 to a lower end of the one or more shroud 90.

The plurality of supporter suction ports 211 may have a same vertical length as suction ports 311, 331, and 371 formed on the plurality of outer panels 30 connected to the side supporters 20, for example, the front panel 34 and the side panel 31, and provided at equal intervals, so that the appearance of the outdoor device 1 has a sense of unity as a whole, and an effective inflow of outdoor air may be possible.

The plurality of supporter suction ports 212 may be formed in each of the side supporters 20 provided in the four corners of the outdoor device 1. In the side supporter 20 positioned in a region through which the outdoor heat exchanger 55 does not pass among the side supporters 20, the plurality of supporter suction ports 212 may not be formed.

Hereinafter, flow of air by operation of an outdoor device of an air conditioner having the above-described structure will be described.

When operation of the outdoor device of an air conditioner starts, a refrigerant may be compressed by driving of the one or more compressor 51, and the compressed refrigerant may be circulated by the refrigerant cycle. When the outdoor device performs a cooling operation, the outdoor heat exchanger 55 may function as a condenser, and the flow of air may be forcibly formed in order to exchange heat with the refrigerant passing through the outdoor heat exchanger 55.

The fan 81 of blowing fan assembly 80 may be rotated by driving of a motor simultaneously with driving of the one or more compressor 51. The air outside of the outdoor device 1 may be suctioned through the four surfaces of the outdoor device 1 by rotation of the fan 81 to pass through the outdoor heat exchanger 55, and the air introduced into the outdoor device 1 by passing through the outdoor heat exchanger 55 may be discharged to the plurality of discharge ports 11 via the fan 81 while passing through the one or more shroud 90.

Even via the plurality of supporter suction ports 212 of the side supporters 20 forming the corners of the outdoor device 1, suction of outdoor air may be possible, and therefore, heat exchange by the suction of the outdoor air may be made possible up to a section in which the outdoor heat exchanger 55 is bent. That is, even in the corners of the outdoor device 1, in which the outdoor heat exchanger 55 is bent, in addition to the four surfaces of the outdoor device 1 on which the plurality of suction ports 311, 331, and 371 are formed, suction of the outdoor air may be achieved, so that heat exchange on an entire surface of the outdoor heat exchanger 55 may be performed. Thus, heat exchange may be performed on the entire surface of the outdoor heat exchanger 55 while adopting structure for reinforcing a strength of the outdoor device 1 using the side supporters 20, and therefore, it is possible to improve heat exchange efficiency whiling reinforcing the strength of the outdoor device 1.

As described above, according to an outdoor device for an air conditioner and a method of manufacturing according to embodiments disclosed herein, side supporters may be provided in portions forming corners of the outdoor device, and outer panels may be provided between the side supporters. Thus, a strength of the corners of the outdoor device and an overall appearance thereof may be improved.

In addition, inclined surfaces forming the corners of the outdoor device may be formed in the side supporters, and therefore, corners of the outdoor device may have an inclined surface rather than forming a right angle. Thus, at a time of transport and installation of the outdoor device, the outdoor device may be more easily taken in and taken out when it is rotated in a narrow space or it passes through an elevator or a door.

In addition, when the side supporter and the plurality of outer panels are coupled to each other, a vertical groove may be provided, so that an operator may manipulate a position of the outdoor device by putting his or her hand into the vertical groove upon transport and installation of the outdoor device, thereby improving an installation and transport properties.

In addition, the plurality of supporter suction ports may be formed on the inclined surface of the side supporters, so that suction of the outdoor air may be possible. Thus, even in the corners of the outdoor device, that is, a section in which the outdoor heat exchanger is bent, heat exchange by suction of the outdoor air may be possible. Thus, heat exchange may be performed on an entire surface of the outdoor heat exchanger while adopting structure for reinforcing a strength of the outdoor device by the side supporters, and therefore, it is possible to improve heat exchange efficiency whiling reinforcing the strength of the outdoor device.

Embodiments disclosed herein provide an outdoor device for an air conditioner, which may be more easily transported and installed while reinforcing a strength of corners thereof, and a method of manufacturing an outdoor device of an air conditioner.

Embodiments disclosed herein further provide an outdoor device of an air conditioner in which suction of outdoor air may be possible, even through corners thereof and a method of manufacturing a side supporter for an outdoor device for an air conditioner.

Embodiments disclosed herein provide an outdoor unit or device of or for an air conditioner that may include a top cover that forms an upper surface of the outdoor unit and in which discharge ports are formed; a base pan that forms a lower surface of the outdoor unit; an outdoor heat exchanger formed along a periphery of the base pan; side supporters that connect the top cover and the base pan and form corners of the outdoor unit; and outer panels, which may be disposed or provided between the side supporters and coupled to the side supporters to form a shape of an outer periphery of the outdoor unit, a plurality of suction ports, through which outside air may be suctioned being formed in a region corresponding to the outdoor heat exchanger. Each of the side supporters may include an inclined surface forming a surface inclined between peripheral surfaces of the outdoor unit neighboring to each other.

Extending surfaces, which may be bent, may be further formed at both side ends of the inclined surface, and each of the extending surfaces may be bent multiple times to be coupled to the outer panels. The extending surface may include a first side surface portion or surface, which may be bent at both side ends of the inclined surface and coplanar with an outer surface of the outer panel; a second side surface portion or surface, which may be bent from the first side surface portion toward the outdoor unit and then extends; and a coupling portion, which may be bent from the second side surface portion toward the outside to be coupled to the outer panels. The second side surface portion and the coupling portion may be disposed perpendicular to each other.

A first side surface portion or surface, which may be bent at both side ends of the inclined surface and coplanar with an outer surface of the outer panel may be formed, and the first side surface portion may form a part or portion of a peripheral surface of the outdoor unit.

A distance between a pair of bent portions on both side surfaces may be formed to be larger than a lateral width of the inclined surface. Vertical grooves spaced apart from each other may be formed between an outer surface of the side supporter and the outer surface of the outer panel.

A periphery of the top cover may be formed to be bent and receive an upper end of the side supporter. A support portion bent at an upper end of the inclined surface to support a lower surface of the top cover may be further formed.

A plurality of supporter suction ports, which may be opened along the inclined surface and supply outdoor air toward the outdoor heat exchanger, may be formed on the inclined surface. The supporter suction ports may be formed between the suction ports of the outer panels disposed or provided on both sides of the supporter. The supporter suction ports may have a same length as that of the suction port positioned at a same height.

The supporter suction ports may be formed in a region between the base pan and a shroud disposed or provided above the outdoor heat exchanger to guide discharge of air. Also, the supporter suction ports may be formed in the side supporter disposed in a position corresponding to a bent corner of the outdoor heat exchanger among the side supporters.

Embodiments disclosed herein further provide a manufacturing method of a side supporter for an outdoor device for an air conditioner that may include supplying a metal sheet having a predetermined length and width; cutting an end portion or end of the metal sheet by press working, and molding a coupling hole or an engaging portion, which may be coupled to an end portion or end of an outer panel, in a coupling portion of a side supporter; and forming a pair of extending surfaces in the side supporter by press working, and bending the extending surfaces multiple times so that the extending surfaces may include an inclined surface forming a corner portion of an outdoor unit or device of the air conditioner. At the time of bending the extending surfaces, a cam punch may be inserted into a space formed when the pair of extending surfaces are bent, and then slidably moved to a lateral side to mold the extending surfaces. The forming and bending may include primarily bending the extending surfaces so that the second side surface portion and coupling portion of the side supporter are bent at a predetermined angle; secondarily bending the extending surfaces so that the second side surface portion is perpendicular to the inclined surface and the second side surface portion is perpendicular to the coupling portion; and thirdly bending the extending surfaces so that the inclined surface is bent to have a predetermined inclination relative to the second side surface portion. Also, a pair of cam punches may be provided, and slidably moved in such a manner that the cam punches become close to each other when the cam punches are taken in the space formed when the pair of extending surfaces are bent and become away from each other when the extending surfaces are processed.

An escape distance depressed in the cam punch in order to mold the extending surface may be formed to be smaller than a sliding distance of the cam punch. Also, the cam punch may bend the extending surface on one side, and then bend the extending surface on the opposite side again. A distance between the pair of extending surfaces may be formed to be larger than a width of the cam punch.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An outdoor device of an air conditioner, comprising:
a top cover that forms an upper surface of the outdoor device and in which a plurality of discharge ports is formed;
a base pan that forms a lower surface of the outdoor device;
an outdoor heat exchanger that extends along a periphery of the base pan;
a plurality of side supporters that connects the top cover and the base pan and forms corners of the outdoor device; and
a plurality of outer panels provided between the plurality of side supporters and coupled to the plurality of side supporters to form a shape of an outer periphery of the outdoor device, wherein a plurality of suction ports, through which outside air is suctioned, is formed in a region of the plurality of outer panels corresponding to the outdoor heat exchanger, and wherein each of the plurality of side supporters includes an inclined surface forming a surface inclined between outer surfaces of neighboring ones of the plurality of outer panels.

2. The outdoor device according to claim 1, wherein extending surfaces are formed at both side ends of the inclined surface, and wherein each of the extending surfaces is bent multiple times to be coupled to the plurality of outer panels, respectively.

3. The outdoor device according to claim 2, wherein each of the extending surfaces includes:
a first side surface bent at the respective side end of the inclined surface and coplanar with an outer surface of the respective outer panel;
a second side surface bent from the first side surface toward an inside of the outdoor device and then extended; and
a coupling portion bent from the second side surface toward the outside to be coupled to the respective outer panel.

4. The outdoor device according to claim 3, wherein the second side surface and the coupling portion extend substantially perpendicular to each other.

5. The outdoor device according to claim 1, wherein a first side surface is bent at both side ends of the inclined surface, which is coplanar with the respective outer surface of a respective outer panel of the plurality of outer panel, and wherein the first side surface forms a portion of a peripheral surface of the outdoor device.

6. The outdoor device according to claim 1, wherein a distance between a pair of bent portions that extend, respectively, from side ends of the inclined surface is larger than a lateral width of the inclined surface.

7. The outdoor device according to claim 1, wherein vertical grooves spaced apart from each other are formed between an outer surface of each side supporter and an outer surface of a respective outer panel of the plurality of outer panels.

8. The outdoor device according to claim 1, wherein a periphery of the top cover is bent and receives upper ends of the plurality of side supporters.

9. The outdoor device according to claim 8, wherein a bent portion is provided at an upper end of the inclined surface to support a lower surface of the top cover.

10. The outdoor device according to claim 1, wherein a plurality of supporter suction ports, which are opened along the inclined surface and supply outside air toward the outdoor heat exchanger, is formed on the inclined surface of each supporter.

11. The outdoor device according to claim 10, wherein the plurality of supporter suction ports is formed between the plurality of suction ports of the plurality of outer panels provided at both sides of the respective supporter.

12. The outdoor device according to claim 11, wherein the plurality of supporter suction ports has a same length as a length of a suction port positioned at a same height.

13. The outdoor device according to claim 10, wherein the plurality of supporter suction ports is formed in a region between the base pan and one or more shroud provided above the outdoor heat exchanger to guide discharge of air.

14. The outdoor device according to claim 10, wherein the plurality of supporter suction ports is formed in each of the plurality of side supporters provided in a position corresponding to a bent corner of the outdoor heat exchanger among the plurality of side supporters.

15. An air conditioner including the outdoor device according to claim 1.

16. A method of manufacturing a side supporter for an outdoor device for an air conditioner, comprising:
supplying a metal sheet having a predetermined length and width;
cutting an end of the metal sheet by press working, and molding at least one coupling hole or at least one engaging portion configured to be coupled to an end of an outer panel of an outdoor device, in a coupling portion of a side supporter; and
forming a pair of extending surfaces in the side supporter by press working, and bending the extending surfaces multiple times so that the plurality of extending surfaces includes an inclined surface configured to form a corner of an outdoor device of an air conditioner, wherein the bending of the plurality of extending surfaces multiple times includes inserting at least one cam punch into a space formed when the pair of extending surfaces is bent, and then slidably moving the at least one cam laterally to mold the pair of extending surfaces.

17. The method according to claim 16, wherein the forming and the bending includes:
primarily bending the pair of extending surfaces so that a first side surface and the coupling portion of the side supporter are bent at a predetermined angle;
secondarily bending the pair of extending surfaces so that the first side surface is perpendicular to the inclined surface and the first side surface is perpendicular to the coupling portion; and
thirdly bending the extending surfaces so that the inclined surface is bent to have a predetermined inclination relative to the first side surface.

18. The method according to claim 16, wherein the at least one cam punch includes a pair of cam punches, which is slidably moved in such a manner that the pair of cam punches moves closer to each other when the pair of cam punches is inserted into the space formed when the pair of extending surfaces is bent and move away from each other after the pair of extending surfaces is processed.

19. The method according to claim 18, wherein an escape distance depressed in each of the pair of cam punches in order to mold the pair of extending surfaces is formed to be smaller than a sliding distance of each of pair of cam punches.

20. The method according to claim 18, wherein the pair of cam punches bends the respective extending surface on one side, and then bends the extending surface on the opposite side again.

21. The method according to claim 16, wherein a distance between the pair of extending surfaces is larger than a width of the at least one cam punch.

22. A side supporter manufactured using the method according to claim 16.

23. An outdoor device of an air conditioner including a plurality of the side supporter according to claim 22, wherein the plurality of side supporters forms corners of the outdoor device.

24. An air conditioner including the outdoor device according to claim 23.

25. A side supporter for an outdoor device for an air conditioner, the side supporter comprising:
an angled surface that extends along a vertical length thereof;
a pair of extending surfaces that extends from lateral side ends of the angled surface and is bent multiple times, wherein each of the pair of extending surfaces includes:
a first side surface bent at the respective side end of the angled surface and configured to be coplanar with an outer surface of a respective outer panel of the outdoor device;
a second side surface bent from the first side surface toward an inside of the outdoor device and then extended; and
a coupling portion bent from the second side surface toward the outside and configured to be coupled to the respective outer panel, wherein a plurality of suction ports is provided along the angled surface in the vertical direction.

26. The side supporter according to claim 25, wherein the second side surface and the coupling portion extend substantially perpendicular to each other.

27. The side supporter according to claim 25, wherein a bent portion is provided at an upper end of the angled surface configured to support a lower surface of a top cover of the outdoor device.

28. An outdoor device including a plurality of the side supporter according to claim 25, wherein the plurality of side supporters forms corners of the outdoor device.

29. An air conditioner including the outdoor device according to claim 28.
